(19) United States
(12) Patent Application Publication
(10) Pub. No.: US 2008/0199384 A1
(43) Pub. Date: Aug. 21, 2008

(54) Process For Producing Silica, Sodium Sulfite and Sodium Hydrogen Sulfite With Sodium Sulfate

(75) Inventor: Yuanjian Lu, Fujian (CN)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA WELLINK SILICA (NANPING) CO. LTD., Nanping (CN)

(21) Appl. No.: 11/916,663

(22) PCT Filed: Jun. 6, 2006
(86) PCT No.: PCT/CN06/01227

§ 371 Date: Mar. 6, 2008

(30) Foreign Application Priority Data
Jun. 10, 2005 (CN) 200510200324.0

(51) Int. Cl. C01B 33/12

(52) U.S. Cl. 423/339

(57) ABSTRACT

The present invention provides a process for producing silica, sodium sulfite and sodium hydrogen sulfite with sodium sulfate, wherein quartz sand, sodium sulfate and carbon are mixed and charged into a furnace for reaction and the obtained solid sodium silicate and sulfur dioxide are used to prepare silica, sodium sulfite and sodium hydrogen sulfite according to the following steps: 1) To produce silica: said solid sodium silicate is dissolved in water and filtered to produce a water glass solution; then sulfuric acid is reacted with said water glass solution to produce precipitated silica and sodium sulfate; and the precipitated silica is washed, filtered, liquefied and dried to produce silica; 2) To produce sodium sulfite: soda is added into a sodium hydrogen sulfite solution to produce sodium sulfite solution; one part of said sodium sulfite solution is concentrated and evaporated to obtain dry sodium sulfite; and the other part of the sodium sulfite solution is reacted with the sulfur dioxide produced during the production of the sodium silicate to produce sodium hydrogen sulfite solution, which can be recycled and reused in step (2); 3) To produce sodium hydrogen sulfite: soda is added into a sodium hydrogen sulfite solution followed by reacting with the sulfur dioxide produced during the production of the sodium silicate to produce a supersaturated sodium hydrogen sulfite solution, which is crystallized and dried to obtain a dry solid sodium hydrogen sulfite. The process of the present invention produces various products at low production cost and without causing environmental problems, and thus it has great practical value.

The present invention refers to a process for producing silica, sodium sulfite and sodium hydrogen sulfite with sodium sulfate.

Precipitated silica, also called light silicon dioxide or white carbon, is used as filler for rubber; as well as lubricant, insulation material, filling material of plastics, paper, paint and textile and white pigment. Nowadays, the most common method to produce silica is the precipitation method. Water glass (sodium silicate) employed in these processes is prepared by reaction of quartz sand with soda (anhydrate sodium carbonate). These processes, however, require a large quantity of soda, resulting in high production cost.

The purpose of the present invention is to provide a new process for producing precipitated silica while reducing the cost of production and environmental problems.

The present invention involves the following reaction schemes:

2Na₂SO₄+2nSiO₂+C→2Na₂O.nSiO₂+2SO₂+CO₂

Na₂O.nSiO₂+H₂SO₄→nSiO₂+Na₂SO₄

Na₂CO₃+NaHSO₃→Na₂SO₃+NaHCO₃

SO₂+Na₂CO₃→2Na₂SO₃+CO₂

SO₂+Na₂SO₃+H₂O→2NaHSO₃

An embodiment of the present invention, therefore, is a process using sodium sulfate to produce silica, sodium sulfite and sodium hydrogen sulfite. Its character lies in using sodium sulfate instead of soda to produce sodium silicate.

In said process sodium sulfate is mixed with quartz sand and carbon and then charged into a furnace for reaction. Preferably quartz sand, sodium sulfate and carbon are in a weight ratio of 118.3-147.9:100:4-12, and the reaction temperature is 1,200-1,500° C. In subsequent steps of the process, the reaction products, i.e. solid sodium silicate and sulfur dioxide, are used to produce silica, sodium hydrogen sulfite and sodium sulfite through the following steps:

(1) To Produce Silica:

The solid sodium silicate (water glass), produced by the reaction of sodium sulfate, quartz sand and carbon, is dissolved in water in a weight ratio of 100:180-488 to form a sodium silicate solution. Solid contents in said sodium silicate solution are allowed to sedimentate and are removed by filtration. After filtration the filtrate is allowed to react with 98% sulfuric acid in a volume ratio of 13-19:1 at 70-100° C. over a period of 1-4 hours. In a preferred embodiment the water glass and the sulfuric acid are metered into the reaction vessel simultaneously and continuously over the whole reaction (precipitation) time. After the precipitation is completed, the suspension is filtered and the filter cake is washed, liquefied and dried to obtain desired precipitated silica.

(2) To Produce Sodium Sulfite:

Soda is dissolved in a sodium hydrogen sulfite solution in a mole ratio of 1:1 to produce a sodium sulfite solution. One part of said sodium sulfite solution is concentrated and evaporated to obtain dry sodium sulfite. The other part of said sodium sulfite solution is used to react with the sulfur dioxide obtained during the production of the sodium silicate in a mole ratio of 1:1 at 20-50° C. to produce a sodium hydrogen sulfite solution, which can be recycled and be reused in step (2) to produce sodium sulfite with soda. This step of the process of the present invention is to quench sulfur dioxide produced as a by-product in the reaction of sodium sulfate, quartz-sand and carbon, and to ensure that no sulfur dioxide goes out of the process. Environmental problems are therefore avoided. In addition, sodium sulfite, a valuable raw material in chemical and paper industries, is obtained.

(3) To Produce Sodium Hydrogen Sulfite:

Soda is dissolved into a sodium hydrogen sulfite solution in a mole ratio of 1:1; said solution is then reacted with sulfur dioxide obtained during the production of the sodium silicate at 20-50° C. to produce a supersaturated solution of sodium hydrogen sulfite, which is crystallized and evaporated to obtain dry solid sodium hydrogen sulfite.

Compared with the existing techniques, the process of the present invention has the following advantages:
(1) Sodium sulfite and sodium hydrogen sulfite are obtained as by-products, which are valuable materials or can be recycled and reused in the process;
(2) Sodium sulfite, for example, can be recycled and reused to quench SO₂ and this reduces the production cost and avoids pollution of the environment;
(3) Sodium sulfate, obtained by the reaction of sulfuric acid and sodium silicate, can be recycled and reused for the production of water glass and it avoids waste water problems and additionally lowers the production cost;
(4) SO₂, obtained as a side product during the reaction of sodium sulfate, quartz sand and carbon, is quenched and thus pollution of the environment is avoided.

The process of the invention can be used as a batch process or a continuous process. A continuous production of water glass or a continuous overall process is preferred. Especially preferred is the use of a thermal insulation horseshoe-flame furnace in a continuous process to produce water glass by using sodium sulfate.

The following examples are intended to demonstrate and explain the present invention without limitation or restriction of the scope of the invention.

### EXAMPLE

Raw materials quartz sand, sodium sulfate and carbon (already smashed) were mixed in a weight ratio of SiO₂:NaSO₄:C=100:81.4:6.5. Said mixture was continuously charged into a thermal insulation horseshoe-flame furnace to react at a temperature of 1420 to 1450° C. At the outlet of the furnace, the resultant solid sodium silicate was continuously discharged, quenched and dissolved with water to form a 3.5M, 29 Be′ water glass solution.

A 5 I reactor was charged with 2.5 I of water and 0.075 I of said water glass solution and heated to 86° C. Subsequently 1.163 I of said water glass solution and 0.072 I of sulfuric acid were metered in simultaneously over a period of 100 minutes. At the completion of the reaction, additional 0.011 I of sulfuric acid was added to adjust the pH to 4.5.

348.1 g silica (BET=185 m²/g) were obtained after filtration, washing and drying.

The filtrate obtained in the filtration of silica was concentrated and evaporated to obtain dry sodium sulfate, which can be recycled and reused in the starting step to produce water glass. 235.14 g sodium sulfate were obtained.

Soda was dissolved in a sodium hydrogen sulfite solution in a mole ratio of soda to sodium hydrogen sulfite of 1:1 to produce a sodium sulfite solution.

To quench gaseous SO₂, which was a side product of the water glass production step, a part of the sodium sulfite solution produced by the reaction of soda with the sodium hydrogen sulfite solution was used. The reaction was carried out at 20-50° C. and a sodium hydrogen sulfite solution was obtained, a part of which was recycled and reused with soda to produce sodium sulfite solution.

The remaining amount of the sodium sulfite solution, which was not used to quench SO₂, was concentrated and evaporated to obtain solid sodium sulfite, which may be sold as a commercial product.

It is also possible to react sulfur dioxide at 20-50° C. with a part of the sodium sulfite solution, obtained by the reaction of soda and sodium hydrogen sulfite solution in a mole ratio of 1:1 to produce a supersaturated solution of sodium hydrogen sulfite. Said sodium hydrogen sulfite solution can then be crystallized and evaporated to obtain dried and solid sodium hydrogen sulfite, which can be used for different applications in chemical industry.

As demonstrated above, the process of the present invention is simple, and allows cutting down the production cost. SO₂, sodium hydrogen sulfite and sodium sulfate, by-products of the different reaction steps, can be recycled and reused in the process. Consequently no waste-water problem exists. Meanwhile, the by-product sodium sulfite is a valuable material for different applications in chemical industry and can therefore be commercialized. Consequently, the process of the present invention has great practical value.

1. A process for producing silica, sodium sulfite and sodium hydrogen sulfite with sodium sulfate, characterized in that quartz sand, sodium sulfate and carbon are mixed and charged into a furnace for reaction and the obtained solid sodium silicate and sulfur dioxide are used to produce silica, sodium sulfite and sodium hydrogen sulfite according to the following steps:
(1) To produce silica: said solid sodium silicate is dissolved into water in a weight ratio of 100:180-488 and filtered to produce a sodium silicate solution; the resultant sodium silicate solution is reacted with 98% sulfuric acid in a volume ratio of 13-19:1 at 70-100° C. for 1-4 hours to produce precipitated silica and sodium sulfate solution; and the precipitated silica is filtered, washed, liquefied and dried to obtain silica;
(2) To produce sodium sulfite: soda is dissolved into a sodium hydrogen sulfite solution in a mole ration of soda to sodium hydrogen sulfite of 1:1 to form a sodium sulfite solution; one part of said sodium sulfite solution is concentrated and dried to obtain dried sodium sulfite, and the other part is allowed to react with sulfur dioxide in a mole ratio of 1:1 at 20-50° C. to obtain a sodium hydrogen sulfite solution, which may be reused to produce sodium sulfite;
(3) To produce sodium hydrogen sulfite: soda is dissolve into a sodium hydrogen sulfite solution in a mole ratio of soda to sodium hydrogen sulfite of 1:1 followed by reacting with the sulfur dioxide produced during the production of the sodium silicate at 20-50° C. to produce supersaturated sodium hydrogen sulfite solution, which is crystallized and dried to obtain dried sodium hydrogen sulfite.

2. The process for producing silica, sodium sulfite and sodium hydrogen sulfite according to claim 1, characterized in that said quartz sand, sodium sulfate and carbon are in a weight ratio of 118.3-147.9:100:4-12, and their reaction temperature is 1,200-1,500° C.

3. The process for producing silica, sodium sulfite and sodium hydrogen sulfite according to claim 1, characterized in that the filtrate obtained at the end of step (1) is washed, concentrated and dried to obtain solid sodium sulfate, which is reused in the process.

4. The process for producing silica, sodium sulfite and sodium hydrogen sulfite according to claim 1, characterized in that said furnace is a thermal insulation horseshoe-flame furnace.
